(19) United States
(12) Patent Application Publication
(10) Pub. No.: US 2023/0324049 A1
(43) Pub. Date: Oct. 12, 2023

(54) Portable Induction Cooking Device

(71) Applicant: Damien Wade, Dallas, TX (US)

(72) Inventor: Damien Wade, Dallas, TX (US)

(21) Appl. No.: 17/658,677

(22) Filed: Apr. 11, 2022

(51) Int. Cl. F24C 1/16; H05B 6/12; H05B 6/10; H05B 6/06

(52) U.S. Cl. CPC F24C 1/16; H05B 6/12; H05B 6/105; H05B 6/062

(57) ABSTRACT

A portable induction cooking and heating device may include a rechargeable battery electrically connected and supplying power to a low voltage induction module. The battery and the induction module may be encased in an insulated container. The induction module may provide energy to an induction coil at the top of the insulated container. A detachable second container, containing uncooked food or liquid, may be affixed on top of the insulated container. An on/off switch may allow for user control. An additional control switch may be activated when the detachable secondary container is attached. Both the on/off switch and additional control switch may be activated for use to enhance user safety.

### FIELD OF THE DISCLOSURE

The present disclosure generally relates to cooking devices, and more particularly to portable cooking devices.

### BACKGROUND

Some induction heating devices require direct and constant connection to a power source such as a gas or electricity. The requirement of a constant and direct power source limits portability of the device by restricting the user to one location. Additionally, other induction heating devices, while portable, require the heating device to be stationary during heating and cooking, restricting the user's motion while in use. These devices must be stationary due to their design. Their designs may be bulky, making them difficult for transport. They may be hot to the touch while in operation, inhibiting the user from carrying the device while in use. These devices do not allow to the user to truly cook ‘on-the-go’. Further, other induction heating devices include a container permanently attached to the heating base. While these devices are rechargeable, portable, and can be used in motion, they require cleaning after every use or change of contents. If a user wishes to make noodles and then popcorn, this device will need to be cleaned before the device could be utilized to cook the second food item, here popcorn. Additionally, if there were two users wishing to use the device, the users would have to clean the permanent container in between users. Cleaning takes time and resources that may not be available to the user(s).

### SUMMARY

Embodiments of the present disclosure relate to a portable induction cooking and heating device. Uncooked food may be contained in a container which attaches to an insulated cup containing a rechargeable battery and a low voltage induction module. The rechargeable battery may be in the base of its insulated container. A charging port may be provided on the outside of the insulated container connected to the battery inside. Thus, the device may not require a constant power source like some induction heating devices on the market.

The food container on top may be detachable, making the device ideal for on-the-go cooking and eating. This top container may interlock with the bottom container. This interlocking feature may allow for cooking while the heating device is in motion. Thus, the device can be used in a moving vehicle or while being carried by the user. Since the top cup is detachable, the bottom container can be used by other users with other detachable cups immediately without the need for cleaning. Similarly, the base can be immediately used by the same user with a detachable cup containing a different type of food without the need for cleaning.

The low voltage induction module may provide magnetic energy to a coil affixed to the top of the insulated cup. A ceramic plate may be affixed to the top of the coil for user safety. A detachable container may then be affixed to the top of the ceramic plate. The energy from the coil beneath the ceramic plate may heat the metal base of the detachable cup, thus cooking the contents of the cup.

### BRIEF DESCRIPTION OF THE DRAWINGS

For a more complete understanding of this disclosure, reference is now made to the following description, taken in conjunction with the accompanying drawings, in which:

FIG. 1 depicts a perspective view of the portable cooking device according to an embodiment of the present disclosure;

FIG. 2 depicts a view of the base unit with an expanded view of the detachable secondary unit according to an embodiment of the present disclosure;

FIG. 3 depicts a perspective view of both sides of the base unit according to an embodiment of the present disclosure; and

FIG. 4 depicts an expanded view of the base unit according to an embodiment of the present disclosure.

### DETAILED DESCRIPTION

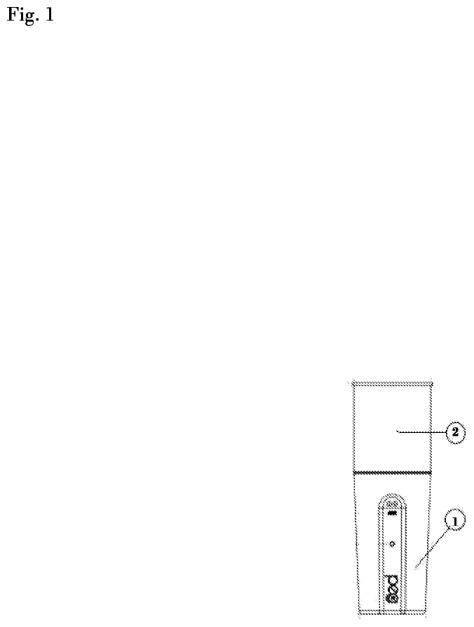

As shown in FIG. 1, the portable cooking device may include base unit 1, detachable secondary unit 2, and control switch 3. In an embodiment of the present disclosure, detachable secondary unit 2 may interlock with base unit 1 via a grooves and thread mechanism. However, other mechanisms for interlocking may be utilized without departing from the present disclosure. Detachable secondary unit 2 provides a chamber for food to be cooked. The detachable nature of detachable secondary unit 2 allows for function as a bowl after cooking is complete. Base unit 1 may be insulated and include control switch 3 on its outer casing for turning the device on and off.

Base unit 1 also may include light emitting diode (LED) indicators 4 for indicating whether the device is turned on and whether the device is charging. While base unit 1 is described as including LED indicators, it should be appreciated that other indicators may be utilized without departing from the present disclosure. Further, base unit 1 may include USB port 5 for a charging cord to be inserted to charge base unit 1. However, it should be appreciated that other charging mechanisms may be utilized as part of base unit 1 without departing from the present disclosure.

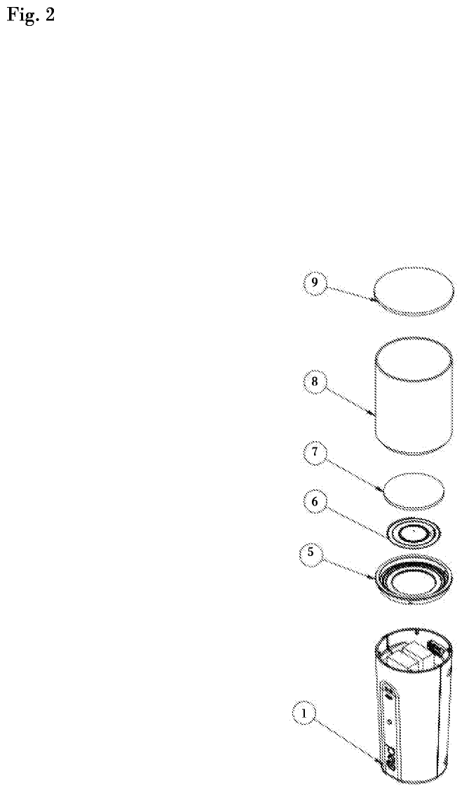

As shown in FIG. 2, coil mounting cover 5, pancake coil 6, and ceramic plate 7 may each be affixed to the top of base unit 1. Ceramic plate 7 may be affixed to pancake coil 6. Pancake coil 6 may be mounted to the coil mounting cover 5. The components of detachable secondary unit 2 may include a food container with metal base 8 that may interlock with base unit 1 and food container lid 9. In an embodiment of the present disclosure, secondary unit base 8 of the food container may be made of aluminum material. However, other materials may be used for secondary unit base 8 without departing from the present disclosure. Ceramic plate 7 may make contact with metal base 8 of detachable secondary unit 2.

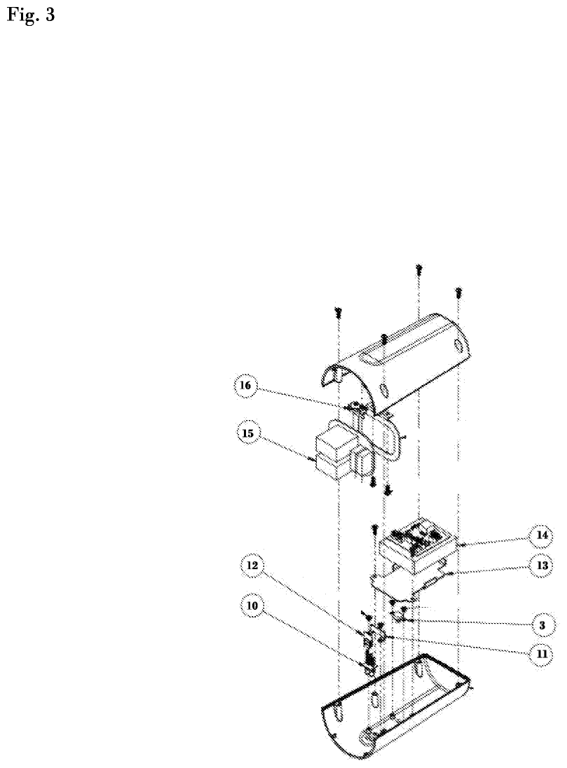

As shown in FIG. 3, base unit 1 may include LED printed circuit board (PCB) 10, USB bracket 11, USB connector 12, control switch 3, battery mount plate 13, rechargeable battery 14, electric inductor 15, and snap action switch 16.

When the control switch 3 is turned to the on position and detachable secondary unit 2 is in the locked position, thus engaging snap action switch 16, rechargeable battery 14 may deliver energy to electric inductor 15. Rechargeable battery 14 may be mounted to battery mount plate 13 which may be used to secure rechargeable battery 14 inside base unit 1. LED PCB 10 may indicate energy is being delivered to electric conductor 15. However, this indication from LED PCB 10 is not necessary for function and has been included for user safety. Electric inductor 15 may generate a high-frequency induction magnetic field to pancake coil 6. In an embodiment of the present disclosure, pancake coil 6 may be a copper coil. However, other types of coils may be used without departing from the present disclosure. Pancake coil 6 may be mounted to base unit 1 by coil mounting cover 5 and may be covered by ceramic plate 7 so that base unit 1 may be cool to the touch when in an on position. When detachable secondary unit 2 is interlocked with base unit 1, metal base 8 of the food container may be heated by energy provided to ceramic plate 7, thus heating the contents of the secondary unit. In an embodiment of the present disclosure, the device may include both control switch 3 and snap action switch 16 for enhanced user safety. USB connector 12 may be connected to rechargeable battery 14 such that when a USB power cable is connected to a power source and inserted into USB port 5, rechargeable battery 14 is recharged for next use. USB connector 12 may be mounted to USB bracket 11 to secure USB connector 12 inside base unit 1.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A portable cooking device comprising:
a base unit comprising:
a coil at a top portion of the base unit;
a low voltage induction module that provides electromagnetic energy to the coil; and
a rechargeable battery electrically connected and supplying power to the low voltage induction module; and
a detachable secondary unit that receives uncooked food, wherein the detachable secondary unit is interlockable with the top portion of the base unit to receive electromagnetic energy from the coil of the base unit to cook the uncooked food.

2. The portable cooking device of claim 1, wherein the base unit is insulated.

3. The portable cooking device of claim 1 wherein the detachable secondary unit is reusable.

4. The portable cooking device of claim 1 further comprising:
a dial that controls temperature.

5. The portable cooking device of claim 1 further comprising:
a timer that controls cook time.
